(19) United States
(12) Patent Application Publication
(10) Pub. No.: US 2005/0167412 A1
(43) Pub. Date: Aug. 4, 2005

(54) Electrical garment heating system

(76) Inventors: Rebecca L. Anson, Meridian, ID (US); Rick L. Anson, Meridian, ID (US)

Correspondence Address: ROBERT L. SHAVER;DYKAS, SHAVER & NIPPER, LLP, P.O. BOX 877, BOISE, ID, 83701-0877, US

(21) Appl. No.: 10/769,525

(22) Filed: Jan. 30, 2004

(51) Int. Cl. H05B 1/00

(52) U.S. Cl. 219/211

(57) ABSTRACT

An system for electrically heating garments is disclosed, which utilizes carbon fibers and a battery pack for a portable power source. Optional features include a thermostat, a and a power switch.

### PRIORITY

This application claims the priority date of the provisional application entitled Electrically Heated Garment filed on Jan. 30, 2004, with Ser. No. 60/443,956, the disclosure of which is incorporated herein.

### DESCRIPTION

### Background of the Invention

1. Field of the Invention

The present invention is directed to an electrically heated article of clothing, and more specifically, directed to an article of clothing which is heated by carbon-impregnated wires, which are positioned within the article of clothing and powered by a portable power source.

2. Background Information

There are a number of situations in which heated garments and articles of clothing are desirable. This usually involves outdoor situations, and can spand a wide range of activities. Such situations can occur when a person is at an outdoor sporting event, such as a football game. At such an event, a blanket can provide some heat to a person, but an electrically heated blanket can provide that much more heat. Similarly, outdoor activities can make electrically heated garments and articles of clothing desirable, including hats, jackets, sleeping bags, socks, gloves, and other articles of clothing.

Military clothing applications exist since the military already uses the “Instant Power” battery/power source for radios and other equipment.

The prior art includes clothing which utilizes electrical resistance wires, and is plugged into an electrical system of a vehicle, such as clothing that is worn on a motorcycle. Another prior art device is socks which are heated by battery power. These socks have a resistance wire generally in the toe region of the sock, which is heated by a batter which is carried by the user.

The disadvantage of the vehicle based heating system is that the electrical heated clothing is not functional unless connected to a vehicle electrical system. It is not practical to carry a vehicle battery away from the vehicle to continue heating this type of clothing. The electrical heated sock is not a particularly affective design, and the heating system of the invention is a great improvement.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The invention is an electrically powered garment heating system. The heating system includes an outer layer of fabric and an inner layer of fabric. Resistance heating wires are positioned adjacent to the inner layer. The heating system includes a thermostat which cuts off power to the resistance heating wires at a prescribed temperature. An important feature of the heating system is that it contains a self-contained power source, and thus the garment may be utilized independently of fixed power sources. It includes a power switch for turning power on and off to the resistance heating wires. The power switch can take a number of configurations, which will be discussed later.

A preferred power source for the heating system is a battery, and several different types of batteries can function in this regard. The electrically powered garment heating system of the invention is applicable to a number of configurations. These include such garments as jackets, gloves, hats, neck gators, helmets, blankets for use outdoors, socks, and sleeping bags. Other garments could equally be adaptable to using the garment heating system of the invention.

A lithium ion battery is one battery which has proven to be particularly adaptable as a power source for the garment heating system. Another suitable power source is a fuel cell. A type of battery which is proven to be particularly successful, is a zinc air cell battery, such as is made by Instant Power. Most of these batteries are rechargeable, but the Instant Power is not, but provide more power that a typical lithium-ion rechargeable battery. The Instant Power batteries are high capacity power sources, and integrate effectively with garment heating system. A similarly sized Instant Power battery has approximately five times the strength of two AA alkaline batteries

Several different types of wire have been successfully used as the resistance heating wires of the invention. Such wires are typically coated with an insulator, such as plastic or PVC. One type of wire which has proven to be especially well adapted to use in the invention, is a wire formed of carbon fibers. This can insulated or non-insulated. Similarly, a wire formed from a material which is carbon-impregnated is also effective in the invention.

The garment heating system includes a power switch, which can take a number of different configurations. A power switch can also have a high and low setting, with the high setting producing more heat, and the lower setting producing less heat, but lasting longer. One type of power switch uses two metallic and magnetized discs. One disc is mounted in the garment surface, while the other disc is on a short strap attached near the first disc. The two discs are attracted to each other by magnetism. When the two discs are allowed to come in contact, the heating unit is activated. One of the discs may be placed in a position that insures that the unit will remain off, by use of hook and loop fastener, a snap, a magnetic retaining disc, or other fasteners.

The purpose of the foregoing abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 perspective of hatband and hat

FIG. 2 perspective of pair of discs used as switch

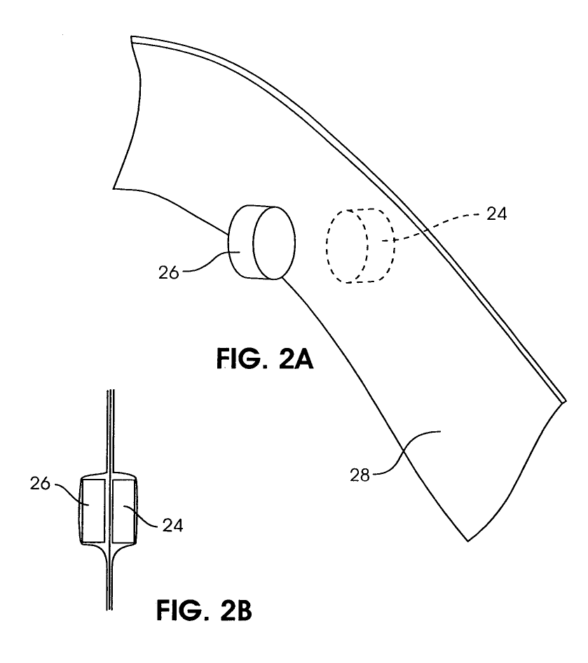

FIG. 3 switch on stalk

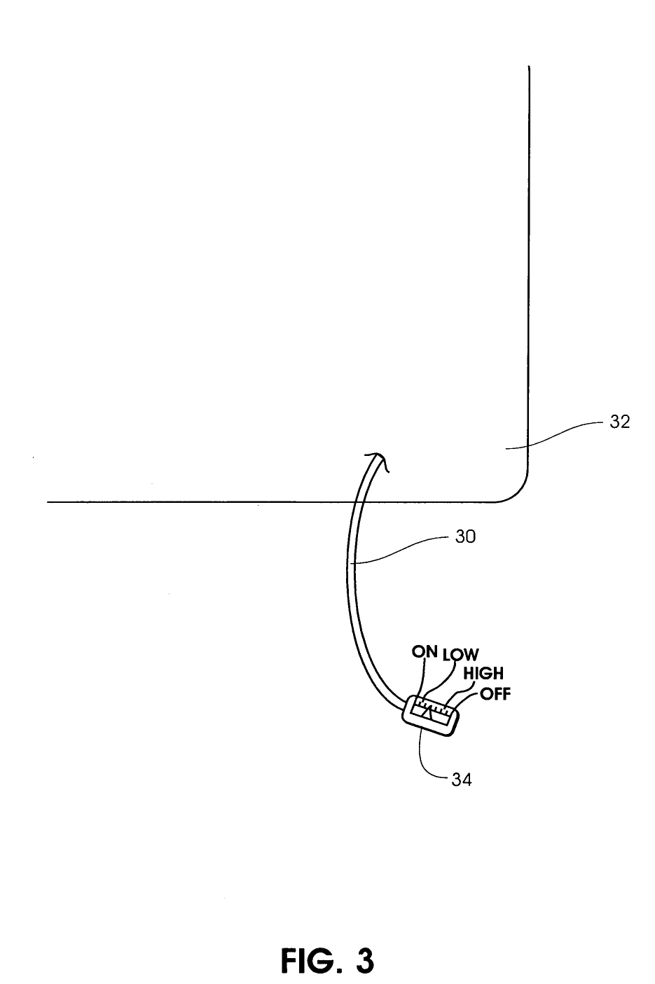

FIG. 4 Perspective as series and parallel in blanket.

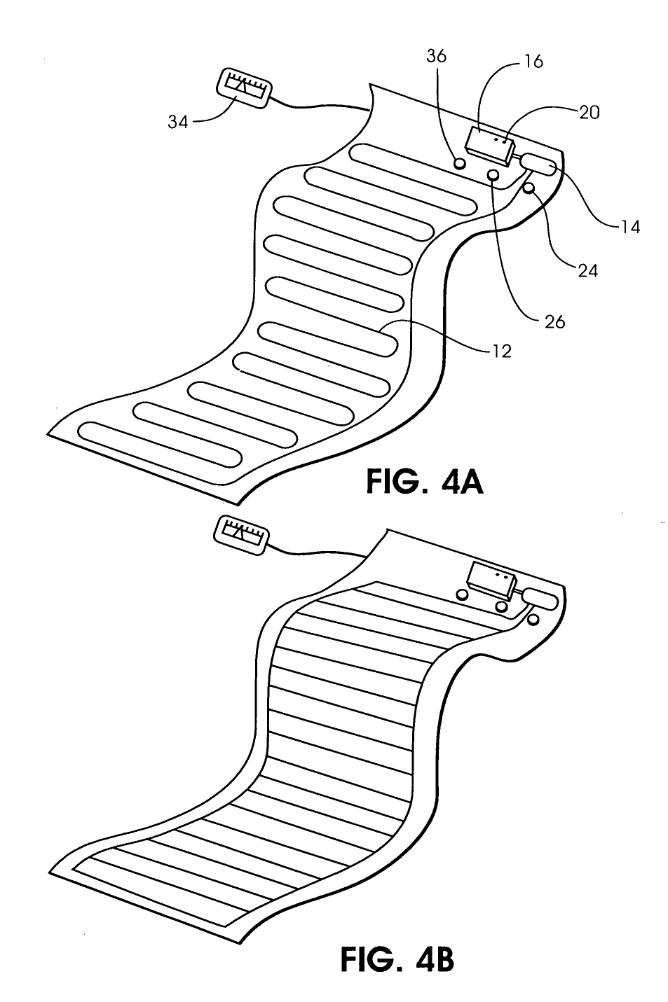

FIG. 5. perspective of blanket with sections.

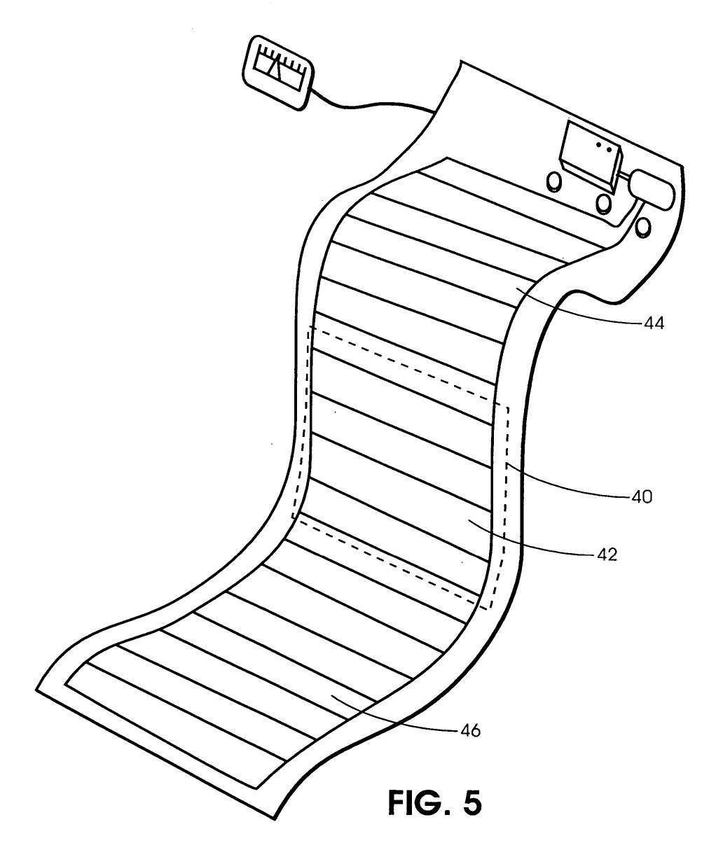

FIG. 6. sleeping bag.

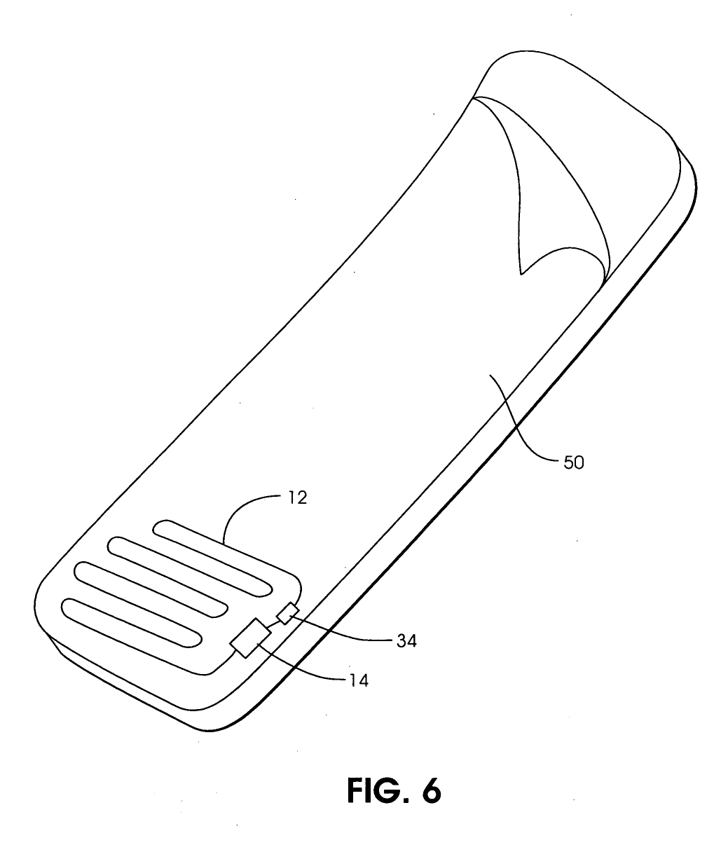

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The preferred embodiment of the present invention is a battery-powered article of clothing that includes a fabric with at least two layers, an outer layer and an inner layer. Resistance heating wires are positioned adjacent to the inner layer, which can either be between the two layers of fabric or on the inner surface of the fleece inner layer. If the wires are on the inner surface of the fleece inner layer, a fabric strip would cover the resistance heating wires.

The device may also include a thermostat for the purpose of cutting off power to the resistance heating wires at a prescribed temperature. The thermostat is preferably a bimetallic strip that shuts off power to the resistance wires when a selected temperature is exceeded. The temperature at which power is cut off can either be permanently set in the unit, or can be controllable by a manual thermostatic control on the device.

One version of the device uses the wire itself to act as a thermostat. The length of the carbon fiber wire, and the type of battery source determine the temperature that is put out by the device. Thus, the system design serves as a preset thermostat.

The device also includes a self-contained power source that would preferably be a battery. One preferred form of the battery is a lithium-ion battery. Other alternative power sources can be used, such as a fuel cell or alternative battery types. The device can also be plugged in to the battery of a vehicle, such as an automobile or a motorcycle, or a battery of the type exemplified by the Instant Power battery, which is a zinc air cell. Activated by oxygen, it is not rechargeable.

The preferred form of the resistance heating wires are carbon fibers encased in flexible insulating material. The flexible insulating material can be rubber, PVC, Teflon, LXPE, or other forms of plastic that are insulative and have the capability of flexing a large number of times without breaking or cracking. Alternatively, the resistance heating wires can be multi-stranded copper.

The use of carbon fiber has many advantages. It is non-metal. Traditional heating materials are metal and have several shortcomings:
Metal becomes hard over time, can crack, oxidizing and is easily broken. When broken it can cause an electrical spark and caused fire.
Metal is not waterproof, it has to be specially coated to be waterproof. This process will make it even harder and bending will gradually damage the insulation. If damaged and exposed to moisture it may cause shock.
Metal is not stable, Compared to metal, carbon is very stable. It will not oxidize. It does not age, is very soft and flexible. The products in which the material is used can be laundered.

Carbon fiber is highly energy efficient. For example, when a heating blanket incorporating two 10 meter lengths of the material connected in parallel is used for 8 hours each night, the energy used will be 6 KW/Hr for a month. This is just 25% of the usage of a 100-Watt bulb used for the same time period.

The preferred carbon fiber is a product made called Duran, made by DuraHeat Company. The technical specifications of Duran carbon fibers are listed below:
General characteristic
   Wire:
      Round Type: 2.0 mm Diameter
         2.5 mm Diameter.
      Flat Type: 3 mm width, 1.2 mm depth
   Color: Black, White and RED
   Resistance per meter: LT24k01, 16.5 ohm
      LT18K, 22 OHM
      LT12k01, 32.5 Ohm
      LT6k01, 70 Ohm
      LT3k01, 130 Ohm
      2% of change within +/−200 degree C.
   Weight per meter: 6 gram
   Electrical:
      Dielectric Voltage: 3000V both for air and water. (apply 3000V, 50 hz, for 5 minutes after soaked one hour in water)
      Insulation Resistance: 3000 M Ohm.
   Mechanical:
      Can be twisted for 55000 times without breaking
   Duran fibers come in several different Series:

Low temperature ThermalTekseries, PVC insulated, DC power source, flat type, and white color.

Low temperature Duran series, PVC insulated, UL approved E206929, 80 Degree C., V0 grade.

High Temperature Thermalmax series, TEFLON (FEP) insulated, 200 Degree C.

Extra Temperature Duranmax series, Isinglass, Mica insulated, 500 Degree C.

The electrically powered garment heating system may have a power switch, or could be turned on and off merely by connecting the battery pack to the resistance wire circuitry. Preferably, the switch has an off setting, and high and low positions. At the high position, the garment would be on with a maximal output. In a low position, the heating garment would operate, but with less heat produced. In the low position, the battery or other power source would last longer. One preferred form of a power switch is a version with two metallic discs. One disc is mounted in the garment surface, and the other disc is on a short strap attached near the first disc. The two discs are attracted to each other by magnetism, and when in contact, the heating unit is activated. The disc on a short strap may be placed by hook and loop or other fasteners to a position that ensures that the unit is off.

An alternative method is to have the switch mounted on a stalk that extends from the garment. The stalk can be an insulated elected wire. The battery powered heating blanket has a power switch. Preferably, the switch has an off setting, and high and low positions. At the high position, the blanket would be on with a maximal output. In a low position, the heating blanket would operate, but with less heat produced. In the low position, the battery or other power source would last longer. The switch for the device would typically be embedded in the surface of the fabric of the blanket. An alternative method is to have the switch mounted on a stalk that extends from the blanket. The stalk can be an insulated elected wire.

The preferred fabric in the device depends on the garment that is made. A fleece jacket is one preferred version, and is made of an outer layer of fleece with a lining layer. Another preferred garment is an inner garment such as the inner layer of a layered clothing system. Such an inner layer is typically a synthetic material such as polypropylene, polyester, chlorifiber, or other wicking synthetic. The preferred fabric in the device is fleece, which is a term used to describe a number of man-made fibers made into a soft fabric. Other materials could be included in various alternative versions of the hat, such as nylon, down, goretex or other breathable waterproof material, cotton, and a number of manmade fibers and insulations

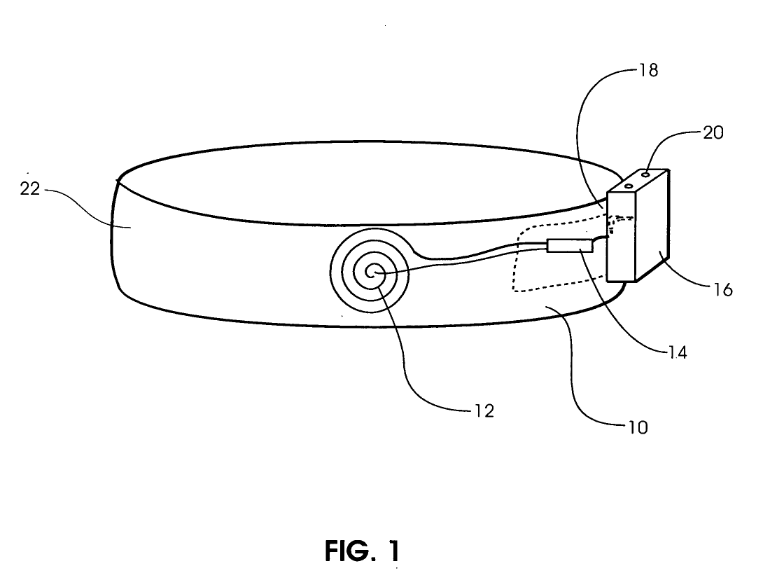

A preferred embodiment of the present invention is a battery powered hat that includes an outer layer that is water and wind resistant, with resistance heating wires positioned adjacent to the inside of the outer layer. A fabric strip or a lining layer would cover the resistance heating wires. The heating elements would preferably be positioned near or at the headband area, and would be covered by a fabric strip. The preferred fabric in the device is a three-layer combination. The outer layer would be of a fabric that is wind and water-resistant. The middle layer is of a wind and waterproof polymer that binds the inner and outer layers together. The inner layer is made of fleece. Basically the same design could be configured as a hat or as a headband, as shown in FIG. 1.

The hat could take a number of alternative forms, including a version with earflaps, a version with a bill like a baseball cap, a fleece stocking cap, and other hat styles. In a version with earflaps, the earflaps could also have heating elements.

The device also includes a liner that is constructed like the hat, but can be configured as a liner for ski boots, and other similar articles. Like the hat, it would typically have a thermostat, an on/off switch, and a battery power source.

Another preferred embodiment of the present invention is a battery powered heating blanket that includes a fabric with at least two layers, an outer layer that is water and wind resistant, and an inner fleece layer. Resistance heating wires are positioned adjacent to the inner layer, which can either be between the two layers of fabric or on the inner surface of the fleece inner layer. If the wires are on the inner surface of the fleece inner layer, a fabric strip would cover the resistance heating wires.

One desirable feature that may be included in the preferred embodiment is to have one or more plug-ins for additional devices. These devices can include a radio, heated gloves, heated earmuffs, or other devices that need a power source.

Another preferred embodiment of the invention is with the heating unit configured for use as a wrap for a seated person. In this configuration, the heating blanket would have a middle seating section with a left and right side portion. The middle seating portion would be configured for someone to sit on, and possibly have internal padding such as foam padding. The right and left side portions would be configured to wrap around the person's lower torso, such as their hips and upper legs. In this configuration, the heating blanket would provide a heating wrap for a seated user.

Another preferred embodiment of the invention is as a portable heating unit configured as a sleeping bag, in which the resistance wires surround a user in a sleeping bag and provide warmth. The sleeping bag may include a built-in foam or inflatable section to be oriented towards the ground surface. The sleeping bag would include a multi-layer sleeping bag cover, which includes an inner layer, resistance heating wires positioned adjacent to the inner layer of the sleeping bag, a thermostat that cuts off power to the resistance heating wires at a prescribed temperature, a self-contained power source, and a power switch for turning power on or off to the resistance heating wires. The sleeping bag version of the device could have the option of including a zip off outer shell, which could be of a windproof material such as nylon, or goretex.

The heating unit of the invention can also be configured so that the resistance heating wires are primarily in the region of the foot box of the sleeping bag so that when activated the feet of the user would receive the heat from the resistance heating wires.

The sleeping bag configuration of the invention can be configured to be a sleeping bag liner, which can be placed inside other sleeping bags. The sleeping bag liner configuration could also be used as an overall body wrap, such as for a person sitting in a stadium, they can put their feet and legs in it and raise it as high above their waist as they choose to. This configuration could also have the thermostat, resistance heating wires, and power switch as described above. The bag liner could include a zipper in the foot area, so a person could open the foot zipper, extend their feet and walk around with the bag liner around their body.

One preferred construction in the device is a three layer combination. The outer layer would be of a fabric that is wind and water-resistant. The middle layer is of a wind and waterproof polymer that binds the inner and outer layers together. The inner layer is made of fleece.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. An electrically powered garment heating system, comprising:
an outer layer fabric, and an inner layer fabric;
resistance heating wires positioned adjacent to said inner layer; and
a self contained power source.

2. The electrically powered garment heating system of claim 1 which further includes a power switch for turning power on and off to the resistance heating wires.

3. The electrically powered garment heating system of claim 1, which further includes a thermostat which cuts off power to the resistance heating wires at a prescribed temperature.

4. An electrically powered garment heating system, comprising:
an outer layer fabric, and an inner layer fabric;
resistance heating wires positioned adjacent to said inner layer;
a thermostat which cuts off power to the resistance heating wires at a prescribed temperature;
a self contained power source; and
a power switch for turning power on and off to the resistance heating wires.

5. The electrically powered garment heating system of claim 1, in which the power source is a battery.

6. The electrically powered garment heating system of claim 1, in which the battery is a lithium ion battery.

7. The electrically powered garment heating system of claim 1, in which the battery is a fuel cell.

8. The electrically powered garment heating system of claim 1, in which the battery is a zinc air.

9. The electrically powered garment heating system of claim in which the thermostat is a bi-metallic strip which shuts off power to the resistance wires when a selected temperature is exceeded.

10. The electrically powered garment heating system of claim 1 in which said resistance heating wires are carbon fiber.

11. The electrically powered garment heating system of claim 1 in which said resistance heating wires are carbon fiber encased in flexible insulating material.

12. The electrically powered garment heating system of claim 1 in which said resistance wires are multi stranded copper.

13. The electrically powered garment heating system of claim 1 in which said power switch includes an off, high, and low position.

14. The electrically powered garment heating system of claim 1 in which said garment includes one or more plug-ins for additional devices.

15. The electrically powered garment heating system of claim 1 in which said switch is embedded in fabric of the garment.

16. The electrically powered garment heating system of claim 1 in which said power switch is a pair of disks which are magnetically attracted to each other, and when in contact cause activation of the heating circuits of said system.

17. An electrically powered garment heating system, comprising:
an outer layer fabric, and an inner layer fabric;
resistance heating wires positioned adjacent to said inner layer;
a thermostat which cuts off power to the resistance heating wires at a prescribed temperature;
a self contained power source; and
a power switch for turning power on and off to the resistance heating wires, comprising a pair of disks which are magnetically attracted, and when in contact, cause activation of the heating circuits of said system.

18. The electrically powered garment heating system of claim 1 in which the power switch is mounted on a stalk which extends from the garment.

19. An electrically powered garment heating system incorporated into a hat, comprising:
a single layer fabric, with an outer water and wind resistant surface;
resistance heating wires positioned adjacent to the head band region of the hat;
a self contained power source; and
a power switch for turning power on and off to the resistance heating wires.

20. The electrically powered garment heating system of claim 17, which further comprises
a two-layer fabric, with an outer water and wind resistant layer, and a fleece inner layer;
resistance heating wires positioned adjacent to said inner layer; and
a thermostat which cuts off power to the resistance heating wires at a prescribed temperature.

21. An electrical powered garment heating system incorporated into a blanket, comprising:
a two-layer fabric, with an outer water and wind resistant layer, and a fleece inner layer;
resistance heating wires positioned adjacent to said inner layer;
a thermostat which cuts off power to the resistance heating wires at a prescribed temperature;
a self contained power source; and
a power switch for turning power on and off to the resistance heating wires.

22. The electrical powered garment heating system incorporated into a blanket of claim 19 in which said blanket includes a plug-in for a radio with headphones.

23. The electrical powered garment heating system incorporated into a blanket of claim 19 in which said blanket includes a plug-in for a radio with headphones in which the headphones are heated and powered by the battery of the blanket, and the headphones are configured to act as earmuffs to the user.

24. The electrical powered garment heating system incorporated into a blanket of claim 19, in which said fabric further comprises a water and wind proof polymer middle layer

25. The electrical powered garment heating system incorporated into a blanket of claim 19 in which said switch is embedded in fabric of the blanket.

26. The electrical powered garment heating system incorporated into a blanket of claim 19 in which the switch is mounted on a stalk which extends from the blanket.

27. The electrical powered garment heating system incorporated into a blanket of claim 19 which is configured to include a middle seating section, and a left side portion and a right portion, in which said middle seating section is configured for a user to sit on, and said left side portion and said right side portions are configured for wrapping said users lower torso, and for providing heat to said user.

28. The electrical powered garment heating system incorporated into a blanket of claim 19 in which said middle seating section includes a foam insert.

29. An electrical powered garment heating system incorporated into a sleeping bag, in which the resistance wires surround a user in the sleeping bag and provide warmth, which comprises:
a multi-layer sleeping bag covering with an inner layer;
resistance heating wires positioned adjacent to said inner layer;
a thermostat which cuts off power to the resistance heating wires at a prescribed temperature;
a self contained power source; and
a power switch for turning power on and off to the resistance heating wires.

30. The portable heating unit of claim 27 in which said heating elements are configured to primarily surround a foot box of said sleeping bag.

31. The portable heating unit of claim 27 in which the sleeping bag is configured to be a liner for a separate sleeping bags.
